(19) United States
(12) Patent Application Publication
(10) Pub. No.: US 2023/0037566 A1
(43) Pub. Date: Feb. 9, 2023

(54) CLIENT-SERVER READING OF MACHINE-READABLE INDICIA

(71) Applicant: Digimarc Corporation, Beaverton, OR (US)

(72) Inventor: Eric D. Evans, Portland, OR (US)

(21) Appl. No.: 17/870,629

(22) Filed: Jul. 21, 2022

Related U.S. Application Data
(60) Provisional application No. 63/224,774, filed on Jul. 22, 2021.

(51) Int. Cl. H04N 19/132; H04N 19/12; G06T 1/00; G06K 7/14; G06K 19/06

(52) U.S. Cl. CPC H04N 19/132; H04N 19/12; G06T 1/0021; G06K 7/1417; G06K 19/06037; G06T 2201/0053

(57) ABSTRACT

Image data depicting a 2D machine-readable code is up-sampled and compressed with a lossy compression process before being sent from a client device to a remote server for code reading. The remote server decompresses the sent information, extracts a payload from the machine-readable code, and causes result information to be sent back to the client device for display or other action. The up-sampling and compression operations performed on the client device can employ software instructions that are downloaded to, and executed by, browser software on the client device. Many other features and arrangements are also detailed.

### RELATED APPLICATION DATA

This application claims priority to provisional application 63/224,774, filed Jul. 22, 2021, the disclosure of which is incorporated herein by reference.

### BACKGROUND

A digital watermark is a form of indicia used to mark items with machine-readable payload data. To decode the payload data from captured image data depicting digital watermark indicia, it is conventional to install watermark reader software on smartphones and other camera-equipped devices, and to extract payload data from the captured image data using such software executed by the device's processor. Some users, however, wish to read digital watermarks from image data without having digital watermark reader software installed on their devices.

This desire can be met by uploading camera-captured image data to a remote service, which applies watermark reading software to the image data, and returns the extracted payload data to the user device. Such process is slowed, however, by the time required to transmit the image data from the user device to the remote service. Attempts to speed such transmission by compressing the image data on the user device, e.g., by JPEG compression, before uploading it to the remote service have been tried but found unsatisfactory. This is because the compression process degrades the representation of the digital watermark signal in the image data, leading to less satisfactory watermark decoding.

In one illustrative embodiment, image data depicting a 2D machine-readable code is up-sampled by a client device before being compressed with a lossy compression process and sent to a remote server for code reading. The remote server decompresses the sent information, extracts a payload from the machine-readable code, and sends result information back to the client device for display or other action. The up-sampling and compression operations can be performed on the client device using software instructions that are downloaded to, and executed by, browser software on the user device.

The foregoing and other features and advantages of the present technology will be apparent from the following detailed description, which proceeds with reference to the accompanying drawings.

### BRIEF DESCRIPTION OF THE DRAWINGS

FIG. 1 is a diagram of one possible embodiment incorporating aspects of the present technology.

FIG. 2 is a flow chart of one possible embodiment incorporating aspects of the present technology.

### DETAILED DESCRIPTION

Applicant has discovered that by up-sampling image data before compressing, the representation of a digital watermark signal in the image data better-survives the compression. Such up-sampling enables smaller image files to be produced and sent to a remote server for reading, with less degradation of the digital watermark signal.

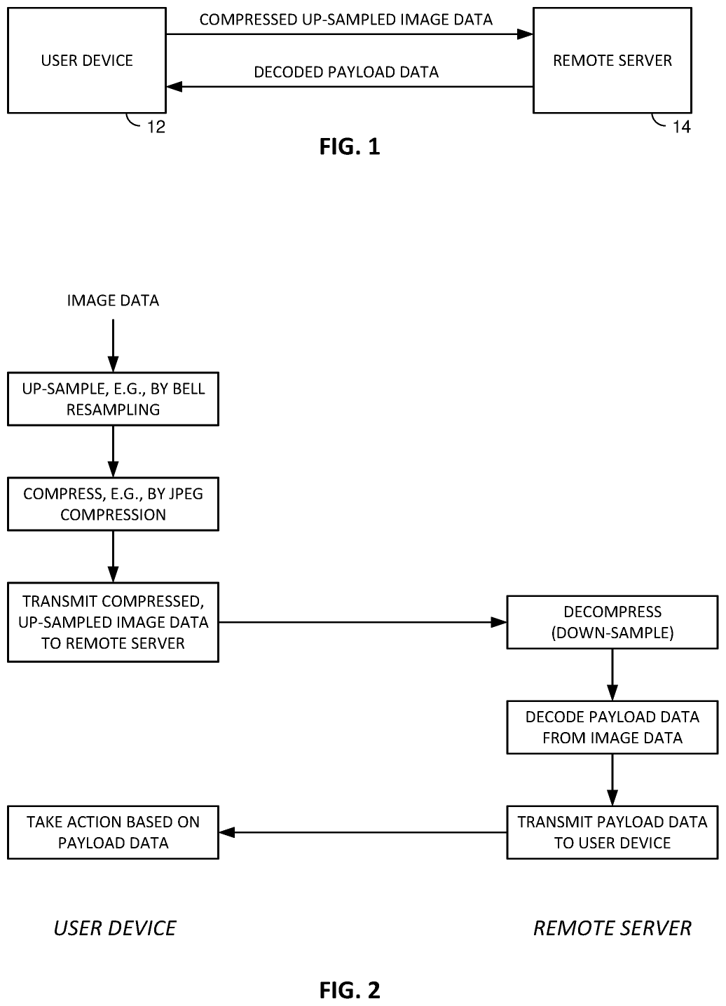

Referring to FIGS. 1 and 2, image data is up-sampled at a user device 12. Up-sampling by a factor of two is exemplary. For example, a 4000×3000 pixel image may be up-sampled to a higher resolution of 8000×6000 pixels. The up-sampled image data is then compressed, and the compressed image data is transmitted to a remote server 14. The server decompresses the image data (e.g., outputting image data of size 8000×6000 pixels), and then extracts payload data from the digital watermark signal represented in the image data. This payload data is then transmitted from the remote server 14, for use by the user device 12.

The image data that is up-sampled needn't be image data directly from the image sensor of the user device. Instead, such sensor data is typically pre-processed in some manner to yield derivative data, such as by one or more of: filtering, demosaicing or other color space conversion (e.g. into greyscale or cyan/magenta/yellow/black), contrast enhancing (e.g., per U.S. Pat. No. 10,182,170), etc., and such derivative data is then up-sampled.

There are many techniques for up-sampling. Most techniques determine the value of a new pixel, spatially located in-between sensor pixels, as a weighted sum of neighboring sensor pixel values. The weightings can vary linearly with spatial position, or polynomial-based weightings can be employed—so-called “B-splines.” A B-spline of order 2 is based on parabolic curves; a B-spline of degree 3 is based on cubic curves; etc. Such weighted sums can be regarded as convolutions, with the convolution kernel k(x) defining the weighting to be given to neighboring pixels, based on their respective distances x, in determining the weighted sum value of an interpolated pixel.

An illustrative embodiment can use Bell resampling, which is a B-spline method of order 2. An illustrative convolution kernel k(x) for Bell resampling can have the form:

$$k ( x ) = \vert \begin{matrix}0.75 - {\vert x \vert}^{2} ; if \vert x \vert < 0.5 \\ 0.5 ⋆ {( \vert x \vert - 1.5 )}^{2} ; if 0.5 < \vert x \vert < 1.5 \\ 0 ; otherwise\end{matrix}$$

Other forms of up-sampling can naturally be used, such as bilinear resampling, Hermite resampling, bicubic resampling, or Mitchell-Netravali resampling. The last three of these are B-spline order 3 techniques. Lanczos resampling can also be used, although this is a slower technique that may make it unsuitable for certain applications.

Similarly, any form of image compression can be used. Lossy image compression is naturally desired in order to achieve the smallest possible representation of the up-sampled image data, and thus the quickest to transmit. Applicant typically uses JPEG compression at a quality setting of between 90 and 25 (on the 0-100 scale of the International JPEG Group). This yields file size reductions on the order of 4:1 to 25:1. JPEG compression employs transform coding based on the Discrete Cosine Transform (DCT). Other compression techniques can employ different technologies, such as wavelet compression, fractal compression, etc.

The transmission of the compressed image data from the user device to the remote server typically employs a wireless transmission channel from the phone, such as cellular data, WiFi, Bluetooth, etc. This data channel may at some point bridge to a wired link (or optical fiber link) that extends to the server using TCP/IP on a wide area network or Ethernet network, etc.

At the server, the compressed image data is decompressed, by a process corresponding to the compression process. The decompression process outputs image data at the up-sampled resolution, e.g., at a resolution of 8000×6000 pixels. This high-resolution data isn't identical to that produced by up-sampling at the user device, due to the lossy compression algorithm, which discards certain high frequency image detail based on inability of the human visual system to discern such detail. But more high frequency image detail is preserved compared to prior art arrangements in which no up-sampling is used prior to compression.

The high-resolution decompressed image data is then provided to a watermark reader. The watermark reader commonly has two parts. The first part is a watermark detector, which detects presence of the watermark signal in the image data, and determines its affine presentation (e.g., scale, rotation and translation). The second part is a watermark decoder, which extracts message “chips” from “waxel” locations in the image data where such data was originally-encoded, and produces from such chips corresponding output payload data.

Additional details of exemplary watermark reading arrangements are found in applicant's previous US patents, including U.S. Pat. Nos. 6,590,996, 9,836,929, 9,959,587, 10,242,434, 10,853,968 and 11,062,108, which also detail various watermark encoding arrangements. (Watermark signals may take different forms, e.g., variations in luminance, variations in chrominance, binary dots vs. variations in continuous-tone imagery, etc.) A commercial software development kit to implement digital watermark reading is available from Digimarc Corporation as the Digimarc Embedded Systems SDK.

The watermark reading process often includes down-sampling of the input image data to produce imagery that represents the watermark signal at a resolution that is closer to that which the imaged item was originally marked. For example, if an item was originally marked with watermark signals as tiled blocks, each of size 512×512 pixels, representing a 128×128 array of watermark elements (“waxels”), then it is customary for the image data to be down-sampled so that the watermark blocks in imagery submitted to the watermark reader are of roughly the same resolution (e.g., having between 350 and 750 pixels on a side, or between 86 and 192 pixels on a side). Due to the up-sampling on the user device, extra down-sampling at the watermark reader may be applied. For example, if the watermark reader normally down-samples by a factor of 4, then the reader may down-sample by a factor of 8 to account for up-sampling by 2 at the user device. (More information on down-sampling in connection with digital watermark reading is provided in pending patent application Ser. No. 16/823,135, filed Mar. 18, 2020, now U.S. Pat. No. 11,367,159, and in published patent applications 20190222715 and 20200311857.)

The payload data output by the watermark reader on the remote server is returned to the user device, e.g., by the same transmission channel(s) used to relay the compressed image data to the server. The user device then acts on the payload data. This can include displaying the payload data to the user, using the payload data to identify a web page for presentation to the user, using the payload data to index a database of metadata about the originally-marked item and present certain of such data to the user, launching a computer application associated with the item, etc. In a particular example, a digital watermark printed on the label of a retail package of fresh berries may link to information identifying the farm and field from which the berries were picked, the picking date, the packaging date, etc. Some or all such information may be presented on a display screen of a smartphone used by a shopper or store manager. Likewise, any use to which payloads of watermark or visible barcodes previously have been put can be employed in conjunction with the present technology, e.g., in connection with supply chain management, brand integrity, and consumer engagement.

Test results from use of the technology were surprising. The usual starting hypothesis is “there's no free lunch.” In the present circumstances it seemed that increasing the resolution would increase the file size, so that improvements in watermark decoding would come at the price of substantially-increased file sizes (and transmission times). But applicant found more is gained than is lost. In particular, comparable watermark reading robustness was achieved with smaller file sizes, using the present technology.

To illustrate, a test image transmitted to the remote server for reading, without up-sampling or compression, had a file size of 247 KB and yielded a watermark robustness score of 476. If up-sampling by 2 is used, with JPEG compression at quality 90, the file size is reduced by more than 50% (to 122 KB), while the watermark robustness score at the server is reduced by less than 8% (to 440).

No watermark could be read at the remote server if the test image was JPEG-compressed at quality 25 without up-sampling. However, if up-sampling by 2 is used prior to JPEG-compression at quality 25, then the watermark becomes readable at the remote server, with a robustness score of 296.

Similarly, no watermark could be read if the image was JPEG-compressed at quality 50 without up-sampling. However, if up-sampling by 2 is used prior to JPEG-compression at quality 50, then the watermark becomes readable, with a robustness score of 373.

In this latter case the compressed image size was 28 KB. To yield a comparable watermark robustness score (i.e., 378 vs. 373), without up-sampling, required that the JPEG quality be increased to 90. This resulted in an image size of 41 KB. Thus, comparable watermark performance was here achieved with a file size of 28 KB using the present technology, as contrasted with a file size of 41 KB using the prior art.

As another example, the same image, without up-sampling and compressed with JPEG quality 95, yielded a file size of 76 KB and a robustness score of 432. The same image, up-sampled by 2 and compressed with JPEG quality 80, yielded a file size of 62 KB and the same robustness score: 432. Thus, identical watermark performance was here achieved with a file size of 62 KB using the present technology, as contrasted with a file size of 76 KB using the prior art.

Put more generally, compression reduces file size more quickly than it reduces robustness. This is believed due to a common characteristic of lossy compression processes: they quantize higher frequencies more coarsely than lower frequencies. By up-sampling the image data, the compression algorithm essentially employs finer quantization—leading to more faithful reproduction of the original image information after decompression.

Thus, to obtain comparable watermark reading performance, file sizes can be smaller, and system response time can thereby be made quicker, if up-sampling is used.

(Techniques for computing watermark robustness scores are detailed in U.S. Pat. Nos. 10,217,182, 7,286,685 and 7,054,461, where such scores are termed the “message strength” metric or the “payload recovery assessment” metric. One such technique for assessing watermark robustness is to add increasing levels of Gaussian noise to the image data provided to the watermark reader, to determine the noise level at which correct payload decoding falls below a threshold value, such as 50%, when averaged over dozens or hundreds of trials.)

From the foregoing it will be recognized that embodiments of the present technology spare users the need to install digital watermark reading software on their devices (which may occupy 10 MB or more of program storage), while enabling quick client-server response times. Moreover, by performing watermark reading operations on a remote server, it is easier to assure that the latest watermark reading software is being used—since only the remote server needs to be kept up to date.

### Concluding Remarks

Having described and illustrated the principles of our inventive work with reference to illustrative examples, it will be recognized that the technology is not so limited.

For example, while the user device is typically equipped with a camera to capture the image data from a subject marked with a machine-readable indicia, this is not required. The user device can obtain the image data from another source.

While marking of items with machine-readable indicia is most commonly done by ink printing, other techniques can be used. These include texturing, laser marking and fabric weaving (e.g., as detailed in pending application Ser. No. 17/347,358, filed Jun. 14, 2021, now published as 20210387399; Ser. No. 17/339,711, filed Jun. 4, 2021, now published as 20210390358; and 63/179,063, filed Apr. 23, 2021). Machine-readable indicia can also be presented on, and read from, computer displays, such as smartphone screens.

Although the focus of this disclosure has been on digital watermark indicia, the same methods can be used with any machine-readable indicia, such as black and white barcodes (e.g., UPC codes, EAN-13 codes, QR codes, DataMatrix codes, PDF417 codes, etc.).

In the illustrative embodiment, the payload data produced by the watermark reader on the remote server is returned to the user device. In other embodiments, however, the remote server (or a third computer) takes an action based on the payload, and a result of this action (e.g., metadata looked-up in a database using the payload) is relayed back to the user device, instead of the payload itself.

While the present technology is described in the context of imagery, the same principles can be applied to other media types as well, such as audio and video. For example, audio can be up-sampled on a user device prior to compression (e.g., by MP3 compression) for transmission to a remote server. The server decompresses the audio and applies the decompressed audio to a digital watermark reader. Resulting payload data extracted from the audio is then returned to the user device. Similarly for video, in which the user device can apply MPEG-4 or H.263 compression to up-sampled video prior to transmission to a remote server for reading of machine-readable indicia.

User device code to perform the up-sampling, compression, transmission of image data, receipt of payload data, and resultant action, can take the form of an “app” program, e.g., downloaded from the Apple or Android appstore. More preferably, however, an app is not used. Instead, such code can comprise instructions downloaded with HTML instructions by a web browser (e.g., Safari, Firefox or Chrome) and executed by a JavaScript and/or WebAssembly capability of the browser. (Binary object code WebAssembly instructions can be produced from a higher level language code, such as C++, using a compiler such as Enscripten. Contemporary browsers commonly provide the runtime environment needed for WebAssembly execution. Such functionality is also appearing in client devices without browsers, e.g., using the Wasmer runtime software.)

The processes and system components detailed in this specification can be implemented as instructions for computing devices, including general purpose processor instructions for a variety of programmable processors, such as microprocessors and systems on a chip (e.g., the Intel Atom, the ARM A8 and Cortex series, the Qualcomm Snapdragon, and the nVidia Tegra 4). Implementation can also employ a variety of specialized processors, such as graphics processing units (GPUs, such as are included in the nVidia Tegra series, and the Adreno 530-part of the Qualcomm Snapdragon processor), and digital signal processors (e.g., the Texas Instruments TMS320 and OMAP series devices, and the ultra-low power Qualcomm Hexagon devices, such as the QDSP6V5A), etc. These instructions can be implemented as software, firmware, etc. These instructions can also be implemented in various forms of processor circuitry, including programmable logic devices, field programmable gate arrays (e.g., the Xilinx Virtex series devices), field programmable object arrays, and application specific circuits—including digital, analog and mixed analog/digital circuitry. Execution of the instructions can be distributed among processors and/or made parallel across processors within a device or across a network of devices. Processing of data can also be distributed among different processor and memory devices. References to “processors,” “modules” or “components” should be understood to refer to functionality, rather than requiring a particular form of implementation.

Implementation can additionally, or alternatively, employ special purpose electronic circuitry that has been custom-designed and manufactured to perform some or all of the component acts, as an application specific integrated circuit (ASIC). Additional details concerning special purpose electronic circuitry are provided in our U.S. Pat. No. 9,819,950.

Software instructions for implementing the detailed functionality can be authored by artisans without undue experimentation from the descriptions provided herein, e.g., written in C, C++, Visual Basic, Java, Python, Tcl, Perl, Scheme, Ruby, etc., in conjunction with associated data.

Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems—special purpose computer systems in which operating system software and application software are indistinguishable to the user (e.g., as is commonly the case in basic cell phones). The functionality detailed in this specification can be implemented in operating system software, application software and/or as embedded system software.

Although disclosed as a complete system, sub-combinations of the detailed arrangements are also separately contemplated (e.g., omitting various of the features of a complete system).

While aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

Moreover, it will be recognized that applicant's technology extends to the server (e.g., web site) from which instructions (e.g., WebAssembly or JavaScript instructions) are downloaded to a user device, for execution by the user device.

To provide a comprehensive disclosure, while complying with the Patent Act's requirement of conciseness, applicant incorporates-by-reference each of the documents referenced herein. (Such materials are incorporated in their entireties, even if cited above in connection with specific of their teachings.) These references disclose technologies and teachings that applicant intends be incorporated into the arrangements detailed herein, and into which the technologies and teachings presently-detailed be incorporated.

In view of the wide variety of embodiments to which the principles and features discussed above can be applied, it should be apparent that the detailed embodiments are illustrative only, and should not be taken as limiting the scope of the invention.

1. A method comprising the acts:
at a first system, receiving input image data depicting a machine-readable indicia;
up-sampling said input image data to yield up-sampled image data;
applying lossy compression to the up-sampled image data, yielding compressed image data; and
transmitting or storing the compressed image data.

2. The method of claim 1 in which the input image data is of size N×M pixels, and the up-sampled image data is of size P×Q pixels, where P>N and Q>M.

3. The method of claim 2 in which P=2N, and Q=2M.

4. The method of claim 1 in which the up-sampling includes applying B-spline resampling of order 2 to the input image data.

5. The method of claim 4 in which the up-sampling includes applying Bell resampling to the input image data.

6. The method of claim 1 in which the image data comprises video data.

7. The method of claim 1 that includes transmitting the compressed image data from the first system to a second, remote system that includes a reader for said machine-readable indicia.

8. The method of claim 7 that includes decompressing the compressed image data at the remote system, reading the machine-readable indicia with said reader to yield payload data, and taking an action with the payload data.

9. The method of claim 8 in which said action includes sending the payload data to the first system.

10. The method of claim 8 in which said action includes accessing additional data using said payload data, and sending said additional data to the first system.

11. The method of claim 1 that includes, with an image sensor of the first system, capturing imagery depicting an item on which the machine-readable indicia is formed by texturing, and providing said imagery, or data derived from said imagery, as said input image data.

12. The method of claim 1 that includes, with an image sensor of the first system, capturing imagery depicting an item on which the machine-readable indicia is formed by laser-marking, and providing said imagery, or data derived from said imagery, as said input image data.

13. The method of claim 1 that includes, with an image sensor of the first system, capturing imagery depicting an item on which the machine-readable indicia is formed by fabric weaving, and providing said imagery, or data derived from said imagery, as said input image data.

14. The method of claim 1 that includes, with an image sensor of the first system, capturing imagery depicting an item on which the machine-readable indicia is formed by ink-printing, and providing said imagery, or data derived from said imagery, as said input image data.

15. A device including a camera, a processor, a memory, the memory storing software instructions, the software instructions configuring the device to perform operations including:
up-sampling image data that corresponds to imagery captured by the camera, to yield up-sampled image data;
compressing the up-sampled image data with a lossy compression process, yielding compressed image data; and
transmitting or storing the compressed image data.

16. The device of claim 15 in which said instructions configure the device to transmit the compressed image data to a remote server, receive result data in response, and take an action based on the result data.

17. The device of claim 16 that further includes a display, wherein said action is to present information using said display, said presented information being based on the result data.

18. The device of claim 15 in which said instructions configure the device to download binary object code from a remote repository and execute said object code, wherein execution of said object code performs said up-sampling and compressing of the image data.

19. A non-transitory computer readable medium containing software instructions operative to cause a processor-equipped device configured thereby to up-sample image data, and compress the up-sampled image data with a lossy compression process.

20. The computer readable medium of claim 19 in which said medium comprises an element of a web server, said web server being operative to deliver said software instructions over a network to a client device, for execution by a processor in the client device.
